(19) United States
(12) Patent Application Publication
(10) Pub. No.: US 2019/0155249 A1
(43) Pub. Date: May 23, 2019

(54) TEXTILE BEAM MANAGEMENT SYSTEM AND TEXTILE BEAM MANAGEMENT METHOD

(71) Applicant: INSTITUTE FOR INFORMATION INDUSTRY, TAIPEI (TW)

(72) Inventors: Ying-Hsun LAI, Tainan City (TW); Yu-Cheng HSIAO, Taipei City (TW); Chi-Cheng CHUANG, Kaohsiung City (TW); Yao-Chung CHANG, Taitung County (TW)

(21) Appl. No.: 15/828,404

(22) Filed: Nov. 30, 2017

(30) Foreign Application Priority Data
Nov. 22, 2017 (TW) 106140608

(51) Int. Cl. G05B 19/406; G06Q 10/06; G06F 21/53; G05B 23/02

(52) U.S. Cl. CPC G05B 19/406; G05B 23/0221; G06F 21/53; G06Q 10/06395

(57) ABSTRACT

A textile beam management method is disclosed. The textile beam management method includes the following operations: reading the textile beam number of the textile beam; detecting a machine number of a machine; establishing a virtual reader, in which the virtual reader corresponds to the machine; registering the machine number in a report-back list; receiving an event of the machine; and saving the event and/or an ending time of a manufacturing process of the machine in the report-back list.

### CROSS-REFERENCE TO RELATED APPLICATION

This application claims the priority benefit of TAIWAN Application serial no. 106140608, filed Nov. 22, 2017, the full disclosure of which is incorporated herein by reference.

### FIELD OF INVENTION

The invention relates to a textile beam management method and a textile beam management system. More particularly, the invention relates to a textile beam management method and a textile beam management system for tracing the textile manufacturing process.

### BACKGROUND

A complete textile manufacturing process requires many sections of manufacturing process. In the existing textile industry, different manufacturing processes are managed by different departments. Therefore, without effective tracking management techniques, when quality problems occur at the end of the textile manufacturing process, it is difficult to identify key issues, and there will be some difficulties in improving and controlling quality. In the textile manufacturing process, the textile beam is the main carrier of the cloth (yarn) segment in the textile industry. Therefore, effectively tracking the textile beam of the manufacturing process may effectively analyze and manage the tracking and quality improvement of textile manufacturing processes.

Traditionally, the method of managing textile beam mainly involves data recorded by handwriting or installation of a reader on each textile machine to detect the manufacturing process of each textile beam. However, data recorded by handwriting is highly erroneous and the data may not be recorded in real time. Furthermore, since there are many textile machines, installation of a reader on each textile machine would make the overall cost of construction too high.

Therefore, how to effectively manage the textile beam, and save the overall cost of constructing the textile system, are the problems needed to be addressed in the art.

### SUMMARY

An aspect of this disclosure is to provide a textile beam management method. The textile beam management method includes the following operations: reading the textile beam number of the textile beam; detecting a machine number of a machine; establishing a virtual reader, in which the virtual reader corresponds to the machine; registering the machine number in a report-back list; receiving an event of the machine; and saving the event and/or an ending time of a manufacturing process of the machine in the report-back list.

Another aspect of this disclosure is to provide a textile beam management system. The textile beam management system includes several machines, a reader, a gateway, and a server. The reader is configured for reading a textile beam number of a textile beam, detecting a machine number of one of the machines, and transmitting the textile beam number and the machine number. The gateway is configured for receiving the number of the textile beam and the machine number from the reader, and the gateway is configured for establishing a virtual reader, in which the virtual reader corresponds to the one of the machines. The gateway is further configured for transmitting the textile beam and the machine number. The server is configured for receiving the textile beam number and the machine number from the gateway, and the server is configured for saving the machine number in a report-back list. The gateway receives an event transmitted by the one of the machines and/or an ending time of a manufacturing process of the one of the machines, and then the gateway transmits the event and/or the ending time of the manufacturing process of the one of the machines to the server through the virtual reader. After the server receives the event and/or the ending time of the manufacturing process of the one of the machines, the server saves the event and/or the ending time of the manufacturing process of the one of the machines in the report-back list.

Therefore, according to the technical concept of the present invention, embodiments of this disclosure are to provide a textile beam management system and a textile beam management method, and in particular, a textile beam management system and a textile beam management method for tracing the textile manufacturing process, so as to effectively manage the textile beam and save the overall cost of constructing the textile system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a textile beam management system according to some embodiments of the present disclosure.

FIG. 2 is a schematic diagram illustrating a gateway according to some embodiments of the present disclosure.

FIG. 3 is a schematic diagram illustrating a report-back list according to some embodiments of the present disclosure.

FIG. 4 is a flow chart illustrating a textile beam management method according to some embodiments of the present disclosure.

FIG. 5A is a flow chart illustrating part of the operations of a textile beam management method according to some embodiments of the present disclosure.

FIG. 5B is a flow chart illustrating another part of the operations of a textile beam management method according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

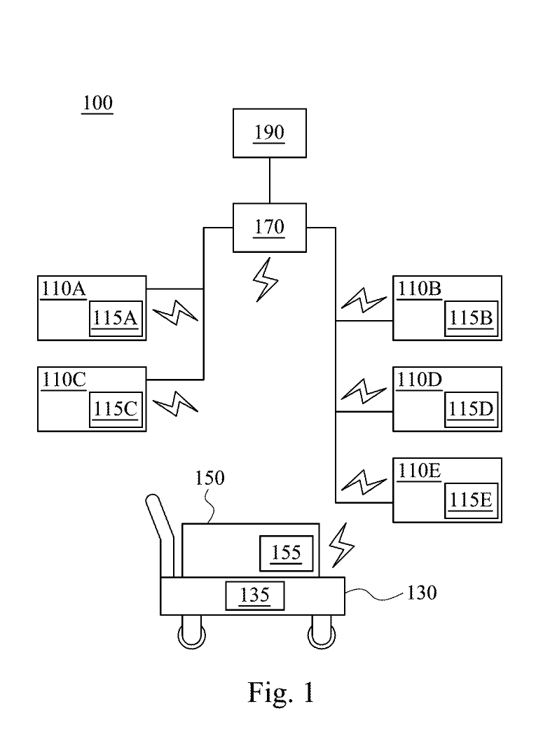

Reference is made to FIG. 1. FIG. 1 is a schematic diagram illustrating a textile beam management system 100 according to some embodiments of the present disclosure. The textile beam management system 100 includes several machines 110A to 110E, a reader 135, a server 190, and a gateway 170. Machines 110A to 110E are communicatively connected to the gateway 170 respectively. The gateway 170 is communicatively connected to the server 190. The reader 135 is communicatively connected to the machines 110A to 110E and the gateway 170, respectively.

The machines 110A to 110E may be machines that perform the same manufacturing process, or machines that perform different manufacturing processes. The manufacturing processes perform by the machines 110A to 110E includes warping (referred to WARP hereinafter), sizing (referred to SIZE hereinafter), beaming (refereed to BEAM hereinafter), weaving (referred to WEAVE hereinafter), and the like. The manufacturing processes listed above are only for illustrative purposes, and the present disclosure is not limited thereto.

In some embodiments, the communicative connection between the machines 110A to 110E and the gateway 170 may be wired communicative connection or a wireless communicative connection. In some embodiments, the gateway 170 and the server 190 may be wired communicatively connected or wireless communicatively connected. In some embodiments, the reader 135 is wireless communicatively connected with the machines 110A to 110E. In some embodiments, the reader 135 and the gateway 170 are wireless communicatively connected.

In some embodiments, the reader 135 is disposed in the cart 130. The cart 130 is configured for carrying and transporting the textile beam 150. In some embodiments, the cart 130 can be also call as the trolley, too. The reader 135 is configured for reading a textile beam number of the textile beam 150 and configured for detecting a machine number of one of the machines 110A to 110E. The reader 135 transmits the textile beam number and the machine number to the gateway 170. The gateway 170 is configured for to receiving the textile beam number and the machine number from the reader 135.

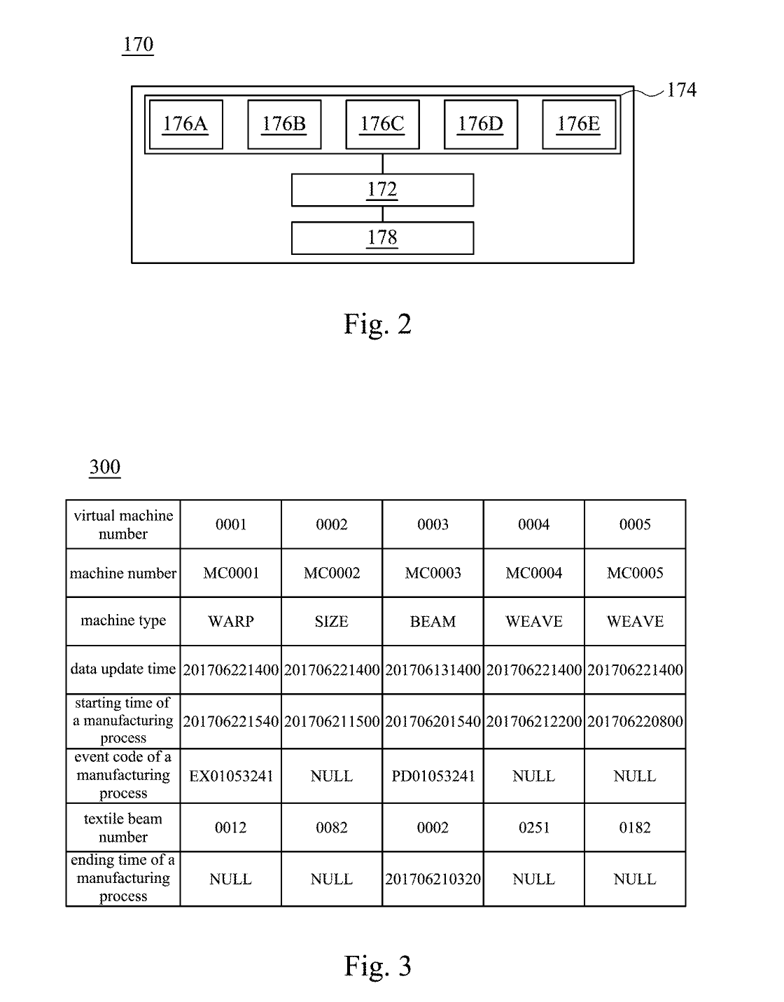

FIG. 2 is a schematic diagram illustrating a gateway 170 according to some embodiments of the present disclosure. Reference is made to FIG. 1 and FIG. 2. As shown in FIG. 2, the gateway 170 includes a processor 172 and a memory 174.

After the gateway 170 receives the textile beam number and the machine number from the reader 135, the gateway 170 establishes one of the virtual readers 176A to 176E in the gateway 170. In some embodiments, gateway 170 is further configured for creating virtual readers 176A to 176E. The virtual readers 176A to 176E correspond to the machines 110A to 110E, respectively.

For example, after the gateway 170 receives the machine number of the machine 110A transmitted from the reader 135, the processor 172 establishes a virtual reader 176A corresponding to the machine 110A in the memory 174. After the gateway 170 receives the machine number of the machine 110B transmitted from the reader 135, the processor 172 establishes a virtual reader 176B corresponding to the machine 110B in the memory 174. And so on, the virtual reader 176C corresponds to the machine 110C. The virtual reader 176D corresponds to the machine 110D. The virtual reader 176E corresponds to the machine 110E.

The gateway 170 transmits the textile beam number and the machine number to the server 190. The server 190 receives the textile beam number and the machine number, and registers the machine number in the report-back list. In some embodiments, the report-back list is stored in the server 190.

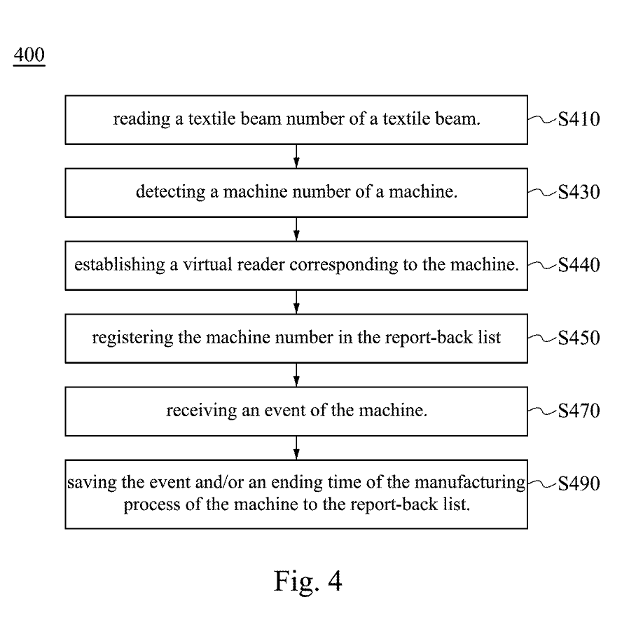

FIG. 3 is a schematic diagram illustrating a report-back list according to some embodiments of the present disclosure. Reference is made to FIG. 1 and FIG. 3. For example, if the cart 130 carries the textile beam 150 to the vicinity of the machine 110A, and the reader 135 reads the textile beam number of the textile beam 150 and detects the machine number of the machine 110A, and the textile beam number of the textile beam 150 and the machine number of the machine 110A are sent to the gateway 170.

After the gateway 170 receives the textile beam number of the textile beam 150 and the machine number of the machine 110A, the gateway 170 registers the machine number of the machine 110A in the report-back list 300. Assuming that the machine number of the machine 110A is MC0001 and the textile beam number of the textile beam 150 is 0012, when the gateway 170 receives the textile beam number of the textile beam 150 and the machine number of the machine 110A, the gateway 170 registers the machine number MC0001 of the machine 110A in the report-back list 300 and the textile beam number of the textile beam 0012 corresponding to the machine number MC0001 is recorded.

The gateway 170 receives an event transmitted by one of the machines 110A to 110E, and the gateway 170 transmits the event of one of the machines 110A to 110E or an ending time of a manufacturing process of one of the machines 110A to 110E to the server 190.

When the gateway 170 transmits the event of one of the machines 110A to 110E or the ending time of the manufacturing process of one of the machines 110A to 110E to the server 190, the gateway 170 transmits information through the virtual readers 176A to 176E which correspond to the machines 110A to 110E respectively. For example, when machine 110A transmits an event or an ending time of a manufacturing process to the gateway 170, the machine 110A transmits the event or the ending time of the manufacturing process of machine 110A to the server 190 through the virtual reader 176A.

After the server 190 receives the event of one of the machines 110A to 110E or the ending time of the manufacturing process of one of the machine 110A to 110E, the server 190 saves the event of one of the machines 110A to 110E or the ending time of the manufacturing process of one of the machines 110A to 110E in the report-back list 300.

Reference is made to FIG. 1 and FIG. 3. Take the virtual machine 0001 as an example, assuming that the encoding of the event is EX01053241, which indicates that the event is an abnormal event. When the textile beam 150 performs a manufacturing process on the machine 110A, the gateway 170 receives the event transmitted by the machine 110A. The event transmitted by the machine 110A includes the code EX01053241, which indicates an abnormal event. After receiving the event transmitted by the machine 110A, the gateway 170 transmits the event transmitted from the machine 110A to the server 190. After receiving the event of the machine 110A, the server 190 saves the event of the machine 110A in the report-back list. That is, as shown in FIG. 3, the event corresponding to the machine number MC0001 of the machine 110A is encoded as EX01053241.

Take the virtual machine 0003 as another example, assuming the machine number of the machine 110C is MC0003, and the textile beam number of the textile beam 150 is 0002. When the textile beam 150 performs a manufacturing process on the machine 110C, the textile beam 150 smoothly completes the manufacturing process at the machine 110C, and thus the machine 110C stops operating. When the machine 110C is stopped, the machine 110C sends the event and the ending time of the manufacturing process to the gateway 170. The event transmitted by the machine 110C includes the code PD01053241, which indicates a stopping event. After receiving the event transmitted by the machine 110C and the ending time of the manufacturing process, the gateway 170 transmits the event and the ending time of the manufacturing process of the machine 110C to the server 190. After the server 190 receives the event of the machine 110C and the ending time of the manufacturing process, the server 190 saves the event of the machine 110C and the ending time of the manufacturing process in the report-back list. That is, as shown in FIG. 3, an event corresponding to the machine number MC0003 of the machine 110C is encoded as PD01053241, and the ending time of the manufacturing process corresponding to the machine number MC0003 of the machine 110C is 201706210320, which indicates a time at 3:20 on June 21, 2017.

In some embodiments, the server 190 further determines whether the event is a stopping event or not. If the server 190 determines that the event is not a stopping event, the server 190 further saves the event in the report-back list 300. Reference is made to FIG. 1 and FIG. 3. Take the virtual machine 0001 as example, assuming that the code of the event is EX01053241, which indicates that the event is an abnormal event. When the textile beam 150 performs a manufacturing process on the machine 110A, the gateway 170 receives the event transmitted by the machine 110A. The event transmitted by the machine 110A includes the code EX01053241, which indicates an abnormal event. After receiving the event transmitted by the machine 110A, the gateway 170 transmits the event transmitted by the machine 110A to the server 190. After the server 190 receives the event of the machine 110A, the server 190 determines that the event of the machine 110A is not a stopping event. Therefore, the server 190 saves the event of the machine 110A in the report-back list 300. That is, as shown in FIG. 3, an event corresponding to the machine number MC0001 of the machine 110A is encoded as EX01053241.

In some embodiments, if the server 190 determines that the event is a stopping event, the server 190 further determines whether a running length of one of the machines 110A to 110E transmitting the event is equal to the target length or not. If the server 190 determines that the running length of one of the machines 110A to 110E that transmitted the event is equal to the target length, the server 190 saves the ending time of the manufacturing process of one of the machines 110A to 110E that transmitted the event in the report-back list 300.

Reference is made to FIG. 1 and FIG. 3. For example, take the virtual machine 0003 as an example, assuming the machine number of the machine 110C is MC0003 and that the textile beam number of the textile beam 150 is 0002. When the textile beam 150 performs a manufacturing process on the machine 110C, the textile beam 150 smoothly completes the manufacturing process at the machine 110C, and thus the machine 110C stops operating. When the machine 110C is stopped, the machine 110C sends the event and the ending time of the manufacturing process to the gateway 170. The event transmitted by the machine 110C includes the code PD01053241, which indicates a stopping event. After receiving the event transmitted by the machine 110C and the ending time of the manufacturing process of the machine 110C, the gateway 170 transmits the event and the ending time of the manufacturing process to the server 190.

After receiving the event and the ending time of the manufacturing process, the server 190 determines whether the running length of the machine 110C transmitting the event is equal to the target length or not. If the server 190 determines that the running length of the server 110C transmitting the event is equal to the target length, the server 190 saves the ending time of the manufacturing process of the machine 110C transmitting the event in the report-back list 300. That is, as shown in FIG. 3, take the virtual machine 0003 as example, an event corresponding to the machine number MC0003 of the machine 110C is encoded as PD01053241 and the ending time of the manufacturing process corresponding to the machine number MC0003 of the machine 110C is 201706210320, which indicates a time at 03:20 on June 21, 2017.

In some embodiments, after the ending time of the manufacturing process of one of the machines 110A to 110E is saved in the report-back list 300, the server 190 is further configured for removing the machine number of one of the machines 110A to 110E from the report-back list 300. Reference is made to FIG. 1 and FIG. 3. For example, after the server 190 saves the event and the ending time of the manufacturing process of the machine 110C in the report-back list 300, the server 190 removes the information corresponding to the machine number MC0003 of the machine 110C from the report-back list 300.

In some embodiments, if the server 190 determines that the running length of one of the machines 110A to 110E that transmitted the event is not equal to the target length, the server 190 determines whether the textile beam 150 on one of the machines 110A to 110E need to be replaced or not. In some embodiments, after replacing the textile beam 150 in one of the machines 110A to 110E, the reader 135 re-reads the textile beam number of the textile beam 150 to detect the machine number of one of the machines 110A to 110E, and send the textile beam number and the machine number to the gateway 170.

In some embodiments, the reader 135 is further configured for detecting several received signal strength indicators (RSSIs) of the machines 110A to 110E and selecting a machine number of the machines 110A to 110E that is corresponding to a largest one of the received signal strength indicators. For example, reference is made to FIG. 1. When the cart 130 carries the textile beam 150 to a position close to the machine 110A, the reader 135 detects several received signal strength indicators of the machines 110A to 110E. Since the machine 110A is closest to the reader 135, the reader 135 detects that the signal strength indicator of the machine 110A is the largest, and the reader 135 selects the machine 110A.

In some embodiments, the server 190 is further configured for determining whether a rotating speed of one of the machines 110A to 110E is less than the rotating speed threshold or not. If the server 190 determines that the rotating speed of one of the machines 110A to 110E is less than the rotating speed threshold, the server 190 selects a machine number of one of the machines 110A to 110E. For example, reference is made to FIG. 1. When the cart 130 carries the textile beam 150 to a position close to the machine 110A, the reader 135 detects several received signal strength indicators of the machines 110A to 110E. Since the machine 110A is closest to the reader 135, the reader 135 selects the machine 110A and transmits the machine number of the machine 110A to the gateway 170. After receiving the machine number of the machine 110A, the gateway 170 transmits the machine number of the machine 110A to the server 190.

After receiving the machine number of the machine 110A, the server 190 determines whether the rotating speed of the machine 110A is less than the rotating speed threshold or not. If the server 190 determines that the rotating speed of the machine 110A is less than the rotating speed threshold, the server 190 selects the machine number of the machine 110A. When the rotating speed of the machine 110A is less than the rotating speed threshold, it indicates that the machine 110A is not being under manufacturing process at this time. The textile beam 150 may be placed on the machine 110A for manufacturing.

In some embodiments, if the server 190 determines that the rotating speed of one of the machines 110A to 110E is not less than the rotating speed threshold, the reader 135 detects multiple received signal strength indicators of the machines 110A to 110E again. For example, the server 190 determines whether the rotating speed of the machine 110A is less than the rotating speed threshold after receiving the machine number of the machine 110A or not. If the server 190 determines that the rotating speed of the machine 110A is not less than the rotating speed threshold, it indicates that the machine 110A is in manufacturing process and the textile beam 150 may not be placed on the machine 110A for manufacturing processing. Therefore, the textile beam 150 needs to be moved by the cart 130 to the vicinity of one of the other machines 110A to 110E, and the reader 135 detects several received signal strength indicators of the machines 110A to 110E again.

In some embodiments, the report-back list 300 further includes the starting time of the manufacturing process of one of the machines 110A to 110E. The server 190 is further configured for determining whether the running length of one of the machines 110A to 110E is equal to zero or not. If the server 190 determines that the running length of one of the machines 110A to 110E is equal to zero, the server 190 resets the starting time of the manufacturing process of one of the machines 110A to 110E in the report-back list 300.

Reference is made to FIG. 1 and FIG. 3. For example, assuming that the textile beam 150 is placed on the machine 110B and is about to begin the manufacturing process, the server 190 determines that the running length of the machine 110B is equal to zero. In some embodiments, a running length equal to zero indicates that the manufacturing process has not started yet. That is, it is not the case that the textile beam 150 is replaced after the manufacturing process is executed with the other textile beam 150. After the server 190 determines that the running length of the machine 110B is equal to zero, the server 190 resets the starting time of the manufacturing process of the machine 110B in the report-back list 300. That is, the server 190 resets the starting time of the manufacturing process corresponding to the machine number MC0002 of the machine 110B to 201706211500 in the report-back list 300, which indicates that the starting time of the manufacturing process is at 15:00 on June 21, 2017.

In some embodiments, the gateway 170 is further configured for transmitting the machine number and the textile beam number of one of the machines 110A to 110E to the server 190 according to the report-back list 300 at predefined intevals. For example, the gateway 170 transmits the machine number and the textile beam number of one of the machines 110A to 110E to the server 190 according to the report-back list 300 every three minutes.

That is, assuming that the textile beam 150 is placed on the machine 110B and is about to start the manufacturing process, the server 190 determines that the running length of the machine 110B is not equal to zero. In some embodiments, a running length equal to zero indicates that the manufacturing process has begun to execute. That is, the textile beam 150 has been exchanged when the manufacturing process has executed to half with the other textile beam 150. After the server 190 determines that the running length of the machine 110B is not equal to zero, the gateway 170 sends the machine number MC0002 of the machine 110B and the textile beam number of the textile beam 150 on the machine 110B to the server 190 every three minutes according to the report-back list 300.

In some embodiments, the machines 110A to 110E send the machine type, running length, rotating speed, etc. to the gateway 170 at predefined intervals. The gateway 170 transmits the machine type, the running length, the rotating speed and the like transmitted by the machines 110A to 110E to the server 190 at predefined intervals.

Reference is made to FIG. 3 again. In some embodiments, the report-back list 300 includes a virtual machine number, a machine number, a machine type, a data update time, a starting time of a manufacturing process, an event code of a manufacturing process, a textile beam number, and an ending time of a manufacturing process.

The virtual machine number indicates a virtual machine number of one of the virtual machines 176A to 176E corresponding to one of the machines 110A to 110E. For example, the machine number of the machine 110 is MC0001, the virtual machine corresponding to the machine 110A is the virtual machine 176A, and the virtual machine number of the virtual machine 176A is 0001, which is displayed in the report-back list 300, and the virtual machine number corresponding to the machine number of the machine 110A corresponding to the MC0001 is 0001.

The machine type represents a section in which one of the machines 110A to 110E is executing. For example, if the machine 110A is performing warping, it is displayed in the report-back list 300 that the machine type corresponding to the machine number MC0001 of the machine 110A is WARP, which indicates warping. In some embodiments, SIZE stands for sizing; BEAM stands for beaming; and WEAVE stands for weaving.

The data update time indicates when the server 190 last updated other data corresponding to the machine number. For example, if the server 190 last updated the data corresponding to the machine number MC0002 at 14:00 on June 22, 2017, it is displayed in the report-back list 300 and the data update time corresponding to the machine number MC0002 of the machine 110B is 201706221400.

The starting time of the manufacturing process indicates the starting time at which the machines 110A to 110E start executing the manufacturing process. For example, if the time when the machine 110B starts to warp is 15:00 on June 21, 2017, it is displayed in the report-back list 300 that the starting time of the manufacturing process corresponding to the machine number MC0002 of the machine 110B is 201706211500.

The event code of a manufacturing process represent encodings included in events transmitted by machines 110A to 110E. Each code represents a different type of event. For example, EX01053241 represents an abnormal event, PD01053241 represents a stopping event, and NULL represents that no specific event was transmitted.

The ending time of the manufacturing process indicates the ending time of the manufacturing process of the machines 110A to 110E. For example, if the ending time of the machine 110C stopping the manufacturing process is at 03:20 on June 21, 2017, the ending time of the manufacturing process corresponding to the machine number MC0003 of the machine 110C displayed in the report-back list 300 is 201706210320. NULL means that the ending time of the manufacturing process is not transmitted, that is, the manufacturing process has not yet completed.

It may be known from the information provided by the report-back list 300 that the machine 100A of the machine number MC0001 has not finished the warping but has an abnormal event. Machine 100B with machine number MC0002 is performing sizing without any abnormal event. Machine 100C with machine number MC0003 has completed beaming. Machine 100D of machine number MC0004 is performing weaving with no abnormal event. Machine 100E of machine number MC0005 is performing weaving with no abnormal event.

Reference is made to FIG. 1 again. In some embodiments, machines 110A to 110E further include communication interfaces 115A to 115E. The textile beam 150 further includes a communication interface 155. The communication interfaces 115A to 115E and the communication interface 155 are configured for transmitting information and/or receiving information. For example, the communication interfaces 115A to 115E and the communication interface 155 may be RFID tags, and the reader 135 may read the machine numbers of the machines 110A to 110E and the textile beam labels of the textile beam 150 through the communication interfaces 115A to 115E and the communication interface 155. In some embodiments, the communication interfaces 115A to 115E may be a wired communication interface and/or a wireless communication interface.

Reference is made to FIG. 2 again. In some embodiments, gateway 170 further includes a communication interface 178. The communication interface 178 is configured for transmitting information and/or receiving information. The communication interface 178 may be a wired communication interface and/or a wireless communication interface for communicating information and/or receiving information with the reader 135 and the communication interfaces 115A to 115E and 155. In some embodiments, the wired communication interface includes a twisted pair, a coaxial cable, an optical fiber, and a home plug. However, the present disclosure is not limited thereto. In some embodiments, the wireless transmission interface includes mobile communication (3G/4G/5G), ZigBeeLoRa, Sigfox, Telensa, Global System for Mobile Communications (WiFi) or Bluetooth, but the present disclosure is not limited thereto.

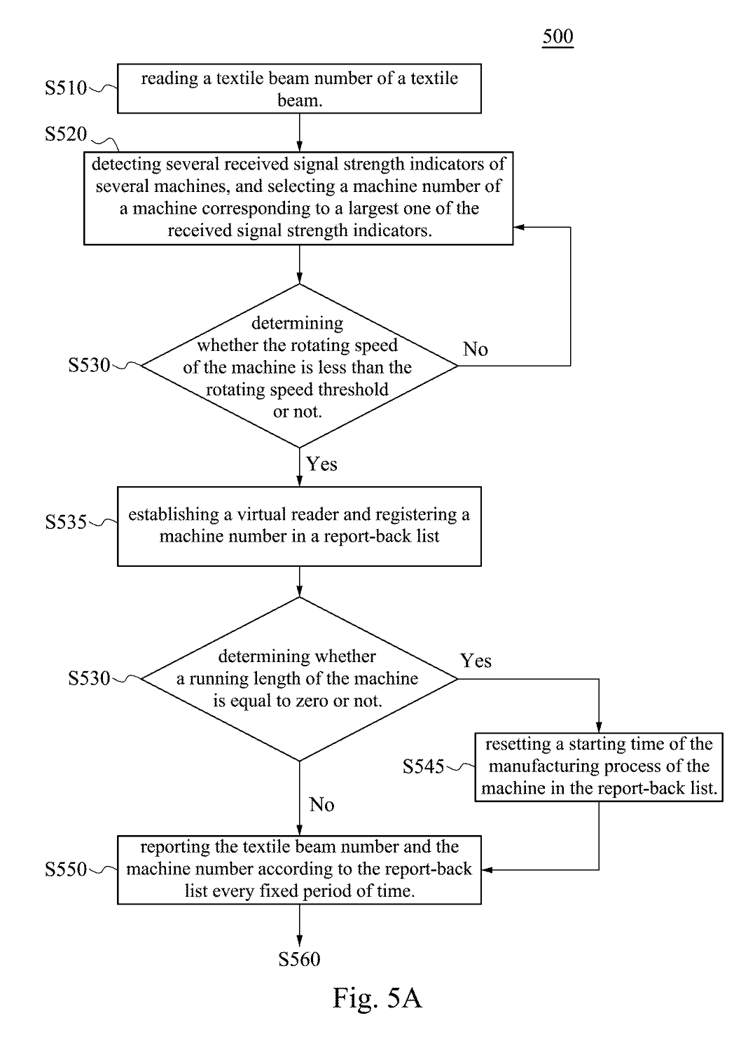

Reference is made to FIG. 4. FIG. 4 is a flow chart illustrating a textile beam management method 400 according to some embodiments of the present disclosure. As shown in FIG. 4, the textile beam management method 400 includes the following operations:

Operation S410: reading a textile beam number of a textile beam;

Operation S430: detecting a machine number of a machine;

Operation S440: establishing a virtual reader corresponding to the machine;

Operation S450: registering the machine number in the report-back list;

Operation S470: receiving an event of the machine; and

Operation S490: saving the event and/or an ending time of the manufacturing process of the machine to the report-back list.

In order to understand the textile beam management method 400 in this embodiment with ease, reference is made to FIG. 1 to FIG. 4.

In operation S410, reading a textile beam number of a textile beam. In some embodiments, operation S410 may be performed by the reader 135. For example, if the cart 130 carries the textile beam 150 to the vicinity of the machine 110A, the reader 135 reads the textile beam number of the textile beam 150.

In operation S430, detecting a machine number of a machine. In some embodiments, operation S430 may be performed by the reader 135. For example, if the cart 130 carries the textile beam 150 to the vicinity of the machine 110A, the reader 135 detects the machine number of the machine 110A.

In operation S440, establishing a virtual reader corresponding to the machine. In some embodiments, operation S440 may be performed by gateway 170. For example, after the gateway 170 receives the machine number of the machine 110A transmitted by the reader 135, the processor 172 establishes, in the memory 174, a virtual reader 176A corresponding to the machine 110A. After the gateway 170 receives the machine number of the machine 110B transmitted by the reader 135, the processor 172 establishes, in the memory 174, a virtual reader 176B corresponding to the machine 110B. And so on, virtual reader 176C corresponds to machine 110C. The virtual reader 176D corresponds to the machine 110D. The virtual reader 176E corresponds to the machine 110E.

In operation S450, registering the machine number in the report-back list. In some embodiments, operation S450 may be performed by the server 190. For example, if the cart 130 carries the textile beam 150 to the machine 110A, the reader 135 reads the textile beam number of the textile beam 150 and detects the machine number of the machine 110A, and then the reader 135 sends the textile beam number of the textile beam 150 and the machine number of the machine 110A to the gateway 170. After the gateway 170 receives the textile beam number of the textile beam 150 and the machine number of the machine 110A, the gateway 170 registers the machine number of the machine 110A in the report-back list 300.

In operation S470, receiving an event of the machine. In some embodiments, operation S470 may be performed by the gateway 170. For example, when the textile beam 150 performs a manufacturing process on the machine 110A, the gateway 170 receives an event transmitted by the machine 110A. The event transmitted by the machine 110A includes the code EX01053241, which indicates an abnormal event. After receiving the event transmitted by the machine 110A, the gateway 170 transmits the event transmitted by the machine 110A to the server 190.

In some embodiments, when the gateway 170 transmits an event of one of the machines 110A to 110E or an ending time of the manufacturing process of one of the machines 110A to 110E to the server 190, the gate 170 transmits information through the virtual readers 176A to 176E corresponding to the machines 110A to 110E respectively. For example, when machine 110A transmits an event or an ending time of the manufacturing process to gateway 170, the machine 110A transmits the event or the ending time of the manufacturing process to server 190 through the virtual reader 176A.

In operation S490, saving the event and/or an ending time of the manufacturing process of the machine to the report-back list. In some embodiments, operation S490 may be performed by the server 190. For example, assuming that a machine number of the machine 110C is MC0003 and a textile beam number of the textile beam 150 is 0002. When the textile beam 150 performs a manufacturing process on the machine 110C, the textile beam 150 smoothly completes the manufacturing process at the machine 110C, and thus the machine 110C stops operating. When the machine 110C is stopped, the machine 110C sends the event and the ending time of the manufacturing process to the gateway 170. The event transmitted by machine 110C includes the code PD01053241, which is indicated as a stopping event. After receiving the event transmitted by the machine 110C and the ending time of the manufacturing process, the gateway 170 transmits the event and the ending time of the manufacturing process to the server 190. After receiving the event and the ending time of the manufacturing process of the machine 110C, the server 190 saves the event and the ending time of the manufacturing process of the machine 110C in the report-back list.

For another example, assuming that the event code is EX01053241, which indicates that the event is an abnormal event. When the textile beam 150 performs a manufacturing process on the machine 110A, the gateway 170 receives the event transmitted by the machine 110A. The event transmitted by the machine 110A includes the code EX01053241, which indicates an abnormal event. After receiving the event transmitted by the machine 110A, the gateway 170 transmits the event transmitted by the machine 110A to the server 190. After receiving the event of the machine 110A, the server 190 saves the event of the machine 110A in the report-back list.

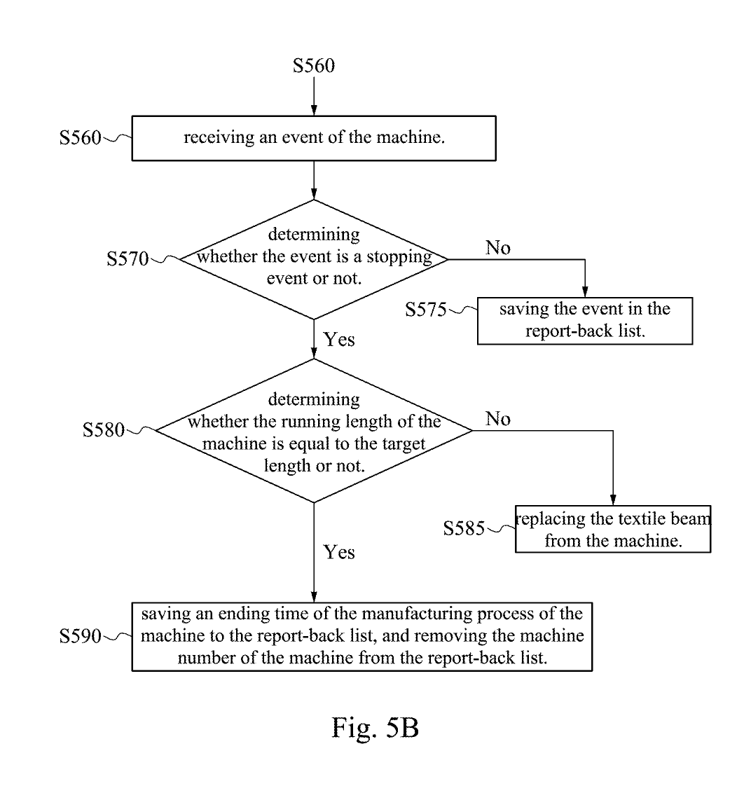

Reference is made to FIG. 5A. FIG. 5A is a flow chart illustrating part of the operations of a textile beam management method 500 according to some embodiments of the present disclosure. As shown in FIG. 5A, the textile beam management method 500 includes the following operations:

Operation S510: reading a textile beam number of a textile beam;

Operation S520: detecting several received signal strength indicators of several machines, and selecting a machine number of a machine corresponding to a largest one of the received signal strength indicators;

Operation S530: determining whether the rotating speed of the machine is less than the rotating speed threshold or not;

Operation S535: establishing a virtual reader and registering a machine number in a report-back list;

Operation S540: determining whether a running length of the machine is equal to zero or not;

Operation S545: resetting a starting time of the manufacturing process of the machine in the report-back list; and

Operation S550: reporting the textile beam number and the machine number according to the report-back list every fixed period of time.

Reference is made to FIG. 5B. FIG. 5B is a flow chart illustrating another part of the operations of a textile beam management method 500 according to some embodiments of the present disclosure. As shown in FIG. 5B, the textile beam management method 500 includes the following operations:

Operation S560: receiving an event of the machine;

Operation S570: determining whether the event is a stopping event or not;

Operation S575: saving the event in the report-back list;

Operation S580: determining whether the running length of the machine is equal to the target length or not;

Operation S585: replacing the textile beam from the machine; and

Operation S590: saving an ending time of the manufacturing process of the machine to the report-back list, and removing the machine number of the machine from the report-back list.

In order to understand the textile beam management method 500 in this embodiment with ease, reference is made to FIG. 1 to FIG. 5B.

In operation S510, reading a textile beam number of a textile beam. In some embodiments, operation S510 is performed by reader 135. For example, if the cart 130 carries the textile beam 150 to the vicinity of the machine 110A, the reader 135 reads the textile beam number of the textile beam 150.

In operation S520, detecting several received signal strength indicators of several machines, and selecting a machine number of a machine corresponding to a largest one of the received signal strength indicators. In some embodiments, operation S520 is performed by the reader 135. For example, the reader 135 detects several received signal strength indicators of several machines 110A to 110E when the cart 130 carries the textile beam 150 to the vicinity of machine 110A.

In operation S530, determining whether the rotating speed of the machine is less than the rotating speed threshold or not. In some embodiments, operation S530 is performed by the server 190. If the determination result in operation S530 is that the rotating speed of the machine is less than the rotating speed threshold, operation S535 is performed. If the determination result in operation S530 is that the rotating speed of the machine is not less than the rotating speed threshold, operation S520 is performed.

For example, the reader 135 detects several received signal strength indicators of the \machines 110A to 110E when the cart 130 carries the textile beam 150 to a position proximate to the machine 110A. Since the machine 110A is closest to the reader 135, the reader 135 selects the machine 110A and transmits the machine number of the machine 110A to the gateway 170. After receiving the machine number of the machine 110A, the gateway 170 transmits the machine number of the machine 110A to the server 190. After receiving the machine number of the machine 110A, the server 190 determines whether the rotating speed of the machine 110A is less than the rotating speed threshold or not.

In operation S535, establishing a virtual reader and registering a machine number in a report-back list. In some embodiments, in operation S535, the virtual reader is established by the gateway 170, and the server 190 registers the machine number in the report-back list 300. For example, if the server 190 determines that the rotating speed of the machine 110A is less than the rotating speed threshold after the server 190 receives the machine number of the machine 110A, the server 190 selects the machine number of the machine 110A, and the machine number MC0001 is registered in the report-back list 300. When the rotating speed of the machine 110A is less than the rotating speed threshold, it indicates that the machine 110A is not being under manufacturing process at this time. The textile beam 150 may be placed on the machine 110A for manufacturing.

In some embodiments, the gateway 170 establishes virtual readers 176A to 176E in the server 190, and the virtual readers 176A to 176E respectively correspond to one of the machines 110A to 110E. For example, after the gateway 170 receives the machine number of the machine 110A transmitted by the reader 135, the processor 172 establishes, in the memory 174, a virtual reader 176A corresponding to the machine 110A. And so on, the virtual reader 176B corresponds to machine 110B. The virtual reader 176C corresponds to the machine 110C. The virtual reader 176D corresponds to the machine 110D. The virtual reader 176E corresponds to the machine 110E.

In some embodiments, when the gateway 170 transmits an event of one of the machines 110A to 110E or an ending time of the manufacturing process of one of the machines 110A to 110E to the server 190, the gateway 170 transmits information through the virtual readers 176A to 176E corresponding to the machines 110A to 110E respectively.

In operation S540, determining whether a running length of the machine is equal to zero or not. In some embodiments, operation S540 is performed by the server 190. If the determination result of S540 is that the running length of the machine is not equal to zero, operation S550 is performed. If the determination result of operation S540 is that the running length of the machine is equal to zero, operation S545 is performed.

For example, assuming that the textile beam 150 is placed on the machine 110B and is about to start the manufacturing process, the server 190 determines whether the running length of the machine 110B is equal to zero or not.

In operation S545, resetting a starting time of the manufacturing process of the machine in the report-back list. In some embodiments, operation S545 is performed by the server 190. For example, assuming that the server 190 determines that the running length of the machine 110B is equal to zero, the server 190 resets the starting time of the manufacturing process of the machine 110B in the report-back list 300. That is, the server 190 resets the starting time of the manufacturing process corresponding to the machine number MC0002 of the machine 110B to 201706211500 in the report-back list 300, which represents that the starting time of the manufacturing process is at 15:00 on June 21, 2017.

In operation S550, reporting the textile beam number and the machine number according to the report-back list every fixed period of time. In some embodiments, operation S550 is performed by the gateway 170. For example, The gateway 170 transmits the machine number MC0002 of the machine 110B and the textile beam number of the textile beam 150 on the machine 110B to the server 190 every three minutes according to the report-back list 300.

In operation S560, receiving an event of the machine. In some embodiments, operation S560 is performed by the gateway 170. For example, the gateway 170 receives an event or an ending time of a manufacturing process transmitted from the machine 110A. In some embodiments, the gateway 170 transmits the event or the ending time of the manufacturing process transmitted from the machine 110A to server 190.

In operation S570, determining whether the event is a stopping event or not. In some embodiments, operation S570 is performed by the server 190. If the determination result in operation S570 is that the event is a stopping event, operation S575 is performed. If the determination result in operation S570 is that the event is not a stopping event, then operation S580 is performed.

For example, assuming that the gateway 170 receives an event transmitted by the machine 110A when the textile beam 150 performs a manufacturing process on the machine 110A. The event transmitted by the machine 110A includes the code EX01053241, which indicates an abnormal event. After receiving the event transmitted by the machine 110A, the gateway 170 transmits the event transmitted by the machine 110A to the server 190. After receiving the event of the machine 110A, the server 190 determines whether the event of the machine 110A is a stopping event or not. Since the event transmitted by the machine 110A is an abnormal event rather than a stopping event, the determination result of the operation S570 is that the event is not a stopping event.

For another example, assuming the machine number of the machine 110C is MC0003 and the textile beam number of the textile beam 150 is 0002. When the textile beam 150 performs a manufacturing process on the machine 110C, the textile beam 150 smoothly completes the manufacturing process at the machine 110C, and thus the machine 110C stops operating. When the machine 110C is stopped, the machine 110C sends the event and the ending time of the manufacturing process to the gateway 170. The event transmitted by machine 110C includes the code PD01053241, which is indicated as a stopping event. Since the event transmitted by the machine 110C is a stopping event, the determination result in the operation S570 is that the event is a stopping event.

In operation S575, saving the event in the report-back list. In some embodiments, operation S575 is performed by the server 190. For example, assuming that the code of the event is EX01053241, which indicates that the event is an abnormal event. When the textile beam 150 performs a manufacturing process on the machine 110A, the gateway 170 receives the event transmitted by the machine 110A. The event transmitted by the machine 110A includes the code EX01053241, which indicates an abnormal event. After receiving the event transmitted by the machine 110A, the gateway 170 transmits the event transmitted by the machine 110A to the server 190. After the server 190 receives the event of the machine 110A, the server 190 determines that the event of the machine 110A is not a stopping event. Therefore, the server 190 saves the event of the machine 110A in the report-back list 300. That is, as shown in FIG. 3, an event corresponding to the machine number MC0001 of the machine 110A is encoded as EX01053241.

In operation S580, determining whether the running length of the machine is equal to the target length or not. In some embodiments, the operation S580 is performed by the server 190. If the determination result in the operation S580 is that the running length of the machine is equal to the target length, operation S590 is performed. If the determination result in the operation S580 is that the running length of the machine is not equal to the target length, an operation S585 is performed.

For example, after receiving the event and the ending time of the manufacturing process of the machine 110C, the server 190 determines whether the running length of the machine 110C transmitting the event is equal to the target length or not.

In operation S585, replacing the textile beam from the machine. In some embodiments, the operation S585 is performed by the server 190. For example, if the machine 110A transmits a stopping event to the gateway 170, the manufacturing process of the machine 110A is not completed, and the textile beam 150 is replaced from the machine 110A. In some embodiments, the server 190 determines whether it is necessary to replace the textile beam 150 of the machine or not before replacing the textile beam 150.

In operation S590, saving an ending time of the manufacturing process of the machine to the report-back list, and removing the machine number of the machine from the report-back list. In some embodiments, the operation S590 is performed by the server 190. For example, after the server 190 saves the ending time and the event of the manufacturing process of the machine 110C in the report-back list 300, the server 190 removes the information corresponding to the machine number MC0003 of the machine 110C from the report-back list 300.

In some embodiments, the processor 172 may be a server, a circuit, a central manufacturing processor unit (CPU), a gateway (MCU) or other device having functions of storing, computing, reading data, receiving signals or information, transmitting signals or information, or other similar functions. In some embodiments, the reader 135 may be a circuit or other device or circuit having the same function of reading information, receiving information and/or transmitting information.

As described above, the textile beam management methods 400 and 500 and the textile beam management system 100 disclosed in the present disclosure read the textile beam number and the machine number through the reader 135 of the cart 130, there is no need to install a reader on each of the machines 110A to 110E, which effectively reduces the construction cost of the overall textile beam management system 100. In addition, in the embodiment of the present disclosure, the virtual readers 176A to 176E are established in the gateway 170, the information is transmitted to the server 190 through the virtual readers 176A to 176E, and the report-back list 300 is established in the server 190. The textile beam management methods 400, 500 and the textile beam management system 100 of the present disclosure may more effectively manage the information of each of the textile beam 150 and the machines 110A to 110E compared to the conventional management by human.

The information corresponding to the textile beam 150 and the machines 110A to 110E includes the machine number, the machine type, the data update time, the starting time of the manufacturing process, the event code of the manufacturing process, the textile beam number, and the ending time of the manufacturing process. The above information is only for illustrative purposes, and the present disclosure is not limited thereto.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other manufacturing processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A textile beam management method, comprising:
reading a textile beam number of a textile beam;
detecting a machine number of a machine;
establishing a virtual reader, wherein the virtual reader corresponds to the machine;
registering the machine number in a report-back list;
receiving an event of the machine; and
saving the event and/or an ending time of a manufacturing process of the machine in the report-back list.

2. The textile beam management method of claim 1, wherein saving the event and/or the ending time of the manufacturing process of the machine in the report-back list comprises:
determining whether the event is a stopping event or not; and
saving the event in the report-back list if the event is not the stopping event.

3. The textile beam management method of claim 2, wherein saving the event and/or the ending time of the manufacturing process of the machine in the report-back list comprises:
determining whether a running length of the machine is equal to a target length or not if the event is a stopping event; and
saving the ending time of the manufacturing process of the machine in the report-back list if the running length of the machine is equal to the target length.

4. The textile beam management method of claim 3, further comprising:
removing the machine number of the machine from the report-back list after saving the ending time of the manufacturing process of the machine in the report-back list.

5. The textile beam management method of claim 1, further comprising transmitting the machine number and the textile beam number at predefined intervals according to the report-back list.

6. The textile beam management method of claim 1, further comprising:
determining whether a running length of the machine is equal to zero or not; and
resetting a starting time of the manufacturing process of the machine in the report-back list if the running length of the machine is equal to zero.

7. The textile beam management method of claim 1, wherein establishing the virtual reader further comprises:
establishing a plurality of virtual readers, wherein the virtual readers correspond to a plurality of machines respectively.

8. The textile beam management method of claim 1, wherein detecting the machine number of the machine further comprises:
detecting a plurality of received signal strength indicators (RSSI) of a plurality of machines; and
selecting the machine number of the machine corresponding to a largest one of the received signal strength indicators.

9. The textile beam management method of claim 8, wherein selecting the machine number of the machine corresponding to the largest one of the received signal strength indicators further comprises:
determining if a rotating speed of the machine is less than a rotating speed threshold; and
selecting the machine number of the machine if the rotating speed of the machine is less than the rotating speed threshold.

10. The textile beam management method of claim 9, further comprising:
detecting the received signal strength indicators of the machines again if the rotating speed of the machine is not less than the rotating speed threshold.

11. A textile beam management system, comprising:
a plurality of machines;
a reader configured for reading a textile beam number of a textile beam, detecting a machine number of one of the machines, and transmitting the textile beam number and the machine number;
a gateway configured for receiving the textile beam number of the textile beam and the machine number from the reader, and configured for establishing a virtual reader, wherein the virtual reader corresponds to the one of the machines, wherein the gateway is further configured for transmitting the textile beam number and the machine number; and
a server configured for receiving the textile beam number and the machine number from the gateway, and configured for saving the machine number in a report-back list;
wherein the gateway receives an event transmitted by the one of the machines and/or an ending time of a manufacturing process of the one of the machines, then the gateway transmits the event and/or the ending time of the manufacturing process of the one of the machines to the server through the virtual reader;
wherein after the server receives the event and/or the ending time of the manufacturing process of the one of the machines, the server saves the event and/or the ending time of the manufacturing process of the one of the machines in the report-back list.

12. The textile beam management system of claim 11, wherein the server is further configured for determining whether the event is a stopping event or not, and if the event is not the stopping event, the server is further configured for saving the event in the report-back list.

13. The textile beam management system of claim 12, wherein if the server determines that the event is the stopping event, the server is further configured for determining whether a running length of the one of the machines is equal to a target length or not, and if the running length of the one of the machines is equal to the target length, the server saves the ending time of the manufacturing process of the one of the machines in the report-back list.

14. The textile beam management system of claim 13, wherein after saving the ending time of the manufacturing process of the machine in the report-back list, the server is further configured for removing the machine number of the machine from the report-back list.

15. The textile beam management system of claim 11, wherein the gateway is further configured for sending the machine number and the textile beam number to the server according to the report-back list at predefined intervals.

16. The textile beam management system of claim 15, wherein the server is further configured for determining whether a running length of the one of the machines is equal to zero or not, and if the running length of the one of the machines is equal to zero, the server resets a starting time of the manufacturing process of the one of the machines in the report-back list.

17. The textile beam management system of claim 11, wherein the gateway is further configured for establishing a plurality of virtual readers, wherein the virtual readers correspond to the plurality of machines respectively.

18. The textile beam management system of claim 11, wherein the reader is further configured for detecting a plurality of received signal strength indicators of the machines and configured for selecting the machine number of the machine corresponding to a largest one of the received signal strength indicators.

19. The textile beam management system of claim 18, wherein the server is further configured for determining whether a rotating speed of the one of the machines is less than a rotating speed threshold or not, and if the rotating speed of the one of the machines is less than the rotating speed threshold, the server selects the machine number of the one of the machines.

20. The textile beam management system of claim 19, wherein the reader detects the received signal strength indicators of the machines if the rotating speed of the one of the machines is not less than the rotating speed threshold.
